(19) United States
(12) Patent Application Publication
(10) Pub. No.: US 2007/0276557 A1
(43) Pub. Date: Nov. 29, 2007

(54) CLUTCH ENGAGEMENT CONTROL APPARATUS AND METHOD FOR HYBRID VEHICLE

(75) Inventors: Jun Motosugi, Sagamihara-shi (JP); Hiroyuki Ashizawa, Yokohama-shi (JP); Kazutaka Adachi, Yokohama-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi (JP)

(21) Appl. No.: 11/752,550

(22) Filed: May 23, 2007

(30) Foreign Application Priority Data
May 26, 2006 (JP) JP2006-146743

(51) Int. Cl. B60L 9/00

(52) U.S. Cl. 701/22; 701/67

(57) ABSTRACT

An apparatus and method for controlling operation of a clutch in a hybrid vehicle. A basic transmission torque capacity target value is calculated based on a vehicle driving operation and a vehicle running condition. A target value for the output side rpm of a clutch is calculated from the basic clutch transmission torque capacity target value. A final transmission torque capacity target value of the clutch, which makes smaller a clutch output side rpm difference Noerr between the clutch output side rpm target value and a clutch output side rpm detection value detected by an rpm detecting device, is calculated, and engagement of the clutch is controlled so that the transmission torque capacity of the clutch becomes equal to the final clutch transmission torque capacity target value.

### CROSS-REFERENCE TO RELATED APPLICATION

This application claims priority from Japanese Patent Application Serial No. 2006-146743, filed May 26, 2006, which is incorporated herein in its entirety by reference.

### TECHNICAL FIELD

The invention relates in general to a hybrid vehicle having installed thereon a plurality of different kinds of power sources such as an engine and a motor-generator, and particularly to controlling clutch engagement.

### BACKGROUND

On example of a clutch engagement control technique is described in Japanese Unexamined Patent Publication No. 2004-203219. The technique therein performs clutch engagement control by supplying oil pressure according to torque produced by a power source so that a clutch transmission torque capacity capable transmitting the torque produced by the power source can be attained.

### SUMMARY

Embodiments of a clutch engagement control apparatus and method for a hybrid vehicle are taught herein. One example of a clutch engagement control apparatus for a hybrid vehicle so disclosed comprises a plurality of different kinds of power sources, a clutch interposed between the power sources and driving wheels, the clutch capable of varying a transmission torque capacity and having an input side and an output side, a clutch output side rpm detecting device that detects an rpm detection value of the output side of clutch and a controller. According to one embodiment, the controller is configured to calculate a basic transmission torque capacity target value of the clutch based on a vehicle driving operation by a driver and a vehicle running condition, calculate a target rpm value for the output side of the clutch based on the basic clutch transmission torque capacity target value, calculate a final transmission torque capacity target value for the clutch that decreases a difference between the target rpm value and the rpm detection value and control engagement of the clutch so that the transmission torque capacity of the clutch becomes equal to the final transmission torque capacity target value.

Other embodiments of a clutch engagement control apparatus for a hybrid vehicle are also taught herein. Where a hybrid vehicle includes a power train having at least two power sources and a clutch between the at least two power sources and a driving wheel, another embodiment comprises means for calculating a basic transmission torque capacity target value of the clutch based on a vehicle driving operation by a driver and a vehicle running condition, means for calculating a target rpm value for the output side of the clutch based on the basic clutch transmission torque capacity target value, means for calculating a final transmission torque capacity target value for the clutch that decreases a difference between the target rpm value and a detected rpm value on the output side of the clutch and means for controlling engagement of the clutch so that the transmission torque capacity of the clutch becomes equal to the final transmission torque capacity target value.

Clutch engagement control methods for such a hybrid vehicle are also taught. For example, one method includes calculating a basic transmission torque capacity target value of the clutch based on a vehicle driving operation by a driver and a vehicle running condition, calculating a target rpm value for an output side of the clutch based on the basic clutch transmission torque capacity target value, calculating a final transmission torque capacity target value for the clutch that decreases a difference between the target rpm value and a detected rpm value on the output side of the clutch and controlling engagement of the clutch so that the transmission torque capacity of the clutch becomes equal to the final transmission torque capacity target value.

### BRIEF DESCRIPTION OF THE DRAWINGS

The description herein makes reference to the accompanying drawings wherein like reference numerals refer to like parts throughout the several views, and wherein:

FIG. 1 is a schematic diagram showing a power train of a hybrid vehicle having a clutch engagement control apparatus according to an embodiment of the invention, with a control system thereof;

FIG. 2 is a flowchart of a control program executed by the integrated controller of FIG. 1;

FIG. 3 is a functional block diagram of the clutch engagement control;

FIG. 4 includes characteristic curves used to obtain a vehicle drive torque target value;

FIG. 5 is a characteristic curve used to obtain a transmission torque capacity of a second clutch of FIG. 1;

FIG. 6 is a characteristic curve used to obtain a clutch oil pressure corresponding to a clutch transmission torque capacity target value;

FIG. 7 is a characteristic curve used to obtain an oil pressure solenoid current for generating a clutch oil pressure obtained based on FIG. 6;

FIG. 8 is a functional block diagram briefly describing control taught herein;

FIG. 9 is a time chart of clutch engagement control according to the functional block diagram of FIG. 8;

FIG. 10 is a functional block diagram briefly describing control taught herein;

FIG. 11 is a time chart of clutch engagement control according to the functional block diagram of FIG. 10;

FIG. 12 is a time chart of clutch engagement control by a clutch engagement control apparatus of FIG. 2 at the time of transition from level road running to slope climbing; and

FIG. 13 is a time chart showing clutch engagement control according to a comparative example.

### DETAILED DESCRIPTION OF EMBODIMENTS OF THE INVENTION

The clutch engagement control in Japanese Unexamined Patent Publication No. 2004-203219 is for feedforward control of clutch oil pressure. Accordingly, the same clutch oil pressure is instructed even when a disturbance such as a variation in road surface slope occurs. This causes a problem in that RPM at the clutch output side varies depending upon such disturbances.

Based on a recognition that the above-described problem results from clutch engagement control disregarding the clutch output side RPM, which varies depending on such disturbances, embodiments of the invention provide a clutch engagement control system for a hybrid vehicle that determines a clutch transmission torque capacity target value in consideration of the clutch output side RPM and controls engagement of the clutch so that the target value is attained.

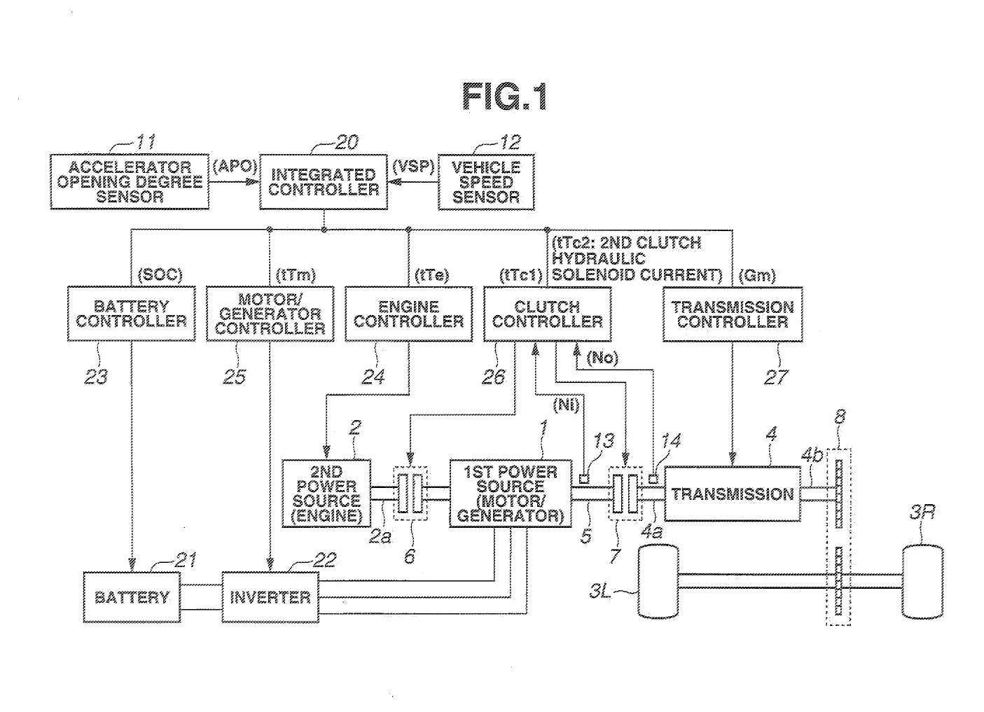

Hereinafter, the invention is described in detail based on embodiments shown in the drawings. FIG. 1 shows a wheel drive system (power train) of a hybrid vehicle having a clutch engagement control apparatus according to an embodiment, together with a control system thereof. The power train includes a motor-generator 1 serving as a first power source, an engine 2 serving as a second power source and left and right drive wheels (here, left and right rear wheels) 3L, 3R, respectively.

In the power train of the hybrid vehicle shown in FIG. 1, similarly to a usual rear wheel drive vehicle, an automatic transmission 4 is disposed in tandem with the engine 2 and rearward thereof with respect to a vehicle front-to-rear direction. A motor-generator 1 is disposed to connect a shaft 5 that transmits rotation of the engine (crankshaft 2a) to an input shaft 4a of the automatic transmission 4.

The motor-generator 1 is an AC synchronous motor adapted to function as a motor to drive of the wheels 3L, 3R and as a generator during regenerative braking of the wheels 3L, 3R. Motor-generator 1 is disposed between the engine 2 and the automatic transmission 4. A first clutch 6 is disposed between the motor-generator 1 and the engine 2. More specifically, first clutch 6 is disposed between the shaft 5 and the engine crankshaft 2a. First clutch 6 separably connects the engine 2 and the motor-generator 1 with each other. In this embodiment, the first clutch 6 is a dry clutch capable of varying a transmission torque capacity continuously or stepwise such as, for example, one that can vary the transmission torque capacity by controlling a clutch engagement force continuously by an electromagnetic solenoid.

A second clutch 7 is interposed between the motor-generator 1 and the automatic transmission 4. More specifically, second clutch 7 is interposed between the shaft 5 and the transmission input shaft 4a. Second clutch 7 separably connects the motor-generator 1 and the automatic transmission 4 with each other. The second clutch 7, similarly to the first clutch 6, is also capable of varying a transmission torque capacity continuously or stepwise, but the second clutch 7 is a wet multi-plate clutch that can vary a transmission torque capacity by, for example, controlling a clutch working oil flow rate and a clutch working oil pressure continuously by a proportional solenoid.

The automatic transmission 4 is the same as that described in pages C-9 to C-22 of “New Skyline (CV35 type vehicle) Service Manual” published on January, 2003 by Nissan Motor Co., Ltd. and adapted to selectively engage or disengage a plurality of friction elements for gear shifting (clutch, brake, etc.) by determining a transmission path (change-speed gear). Accordingly, automatic transmission 4 changes the speed of rotation of the input shaft 4a with a gear ratio corresponding to selected change-speed gear and outputs it to the output shaft 4b. The output rotation is distributed by a final reduction gear 8 to the left and right rear wheels 3L, 3R for driving of the vehicle. Automatic transmission 4 is not limited to the above-described stepwise variable type but can, of course, be a conventional continuously variable transmission (CVT).

In the above-described power train of the hybrid vehicle shown in FIG. 1, an electric vehicle (EV) mode is generally used at low load-low speed, including starting from a stopped position. In EV mode, the first clutch 6 is disengaged and the second clutch 7 is engaged to put the automatic transmission 4 into a power transmission condition where only output rotation from the motor-generator 1 reaches the transmission input shaft 4a. According to a selected change-speed gear, automatic transmission 4 changes the speed of rotation supplied to the input shaft 4a to obtain a desired output speed at the transmission output shaft 4b. The rotation from the transmission output shaft 4b is then transmitted by way of a final reduction gear unit 8 including a differential gear to the left and right rear wheels 3L, 3R such that the vehicle performs EV running by being driven only by the motor-generator 1.

A hybrid (HEV) mode is used at high-speed or at high-load running (where, at the time, the power that can be taken out from the battery is minimal). In the HEV mode, the first clutch 6 and the second clutch 7 are both engaged to put the automatic transmission 4 into a power transmission condition where the output rotation from the engine 2 or both of the output rotation from the engine 2 and the output rotation from the motor-generator 1 reach the transmission input shaft 4a. Automatic transmission 4 changes the speed of rotation supplied to the input shaft 4a according to the selected change-speed gear to obtain a desired output speed at the transmission output shaft 4b. The rotation from the transmission output shaft 4b is then transmitted through the final reduction gear unit 8 to the left and right rear wheels 3L, 3R such that the vehicle can perform HEV running by being driven by both of the engine 2 and the motor-generator 1.

During such HEV running, a surplus of energy caused when the engine 2 is operated can be converted to electric power by operating, with the surplus of energy, the motor-generator 1 as a generator. The generated electric power is collected for use in motor driving of the motor-generator 1, whereby it becomes possible to improve the fuel consumption of the engine 2.

While in FIG. 1 the second clutch 7 is disposed between the motor-generator 1 and the automatic transmission 4, the second clutch 7 can be interposed between the automatic transmission 4 and the final reduction gear unit 8 or can be performed by the same gear shifting friction elements provided within the automatic transmission 4 for selection of change-speed gears.

FIG. 1 further shows a control system for the engine 2, the motor-generator 1, the first clutch 6, the second clutch 7 and the automatic transmission 4, which constitute the power train of the hybrid vehicle. The control system in FIG. 1 includes an integrated controller 20 for controlling the operating point of the power train using an engine torque target value tTe, a motor-generator target value (this can either be a motor generator torque target value tTm or it can be a motor-generator rpm target value tNm), a transmission torque capacity target value tTc1 of the first clutch 6, a transmission torque capacity target value tTc2 (which can be clutch oil pressure solenoid current) of the second clutch 7 and a target change-speed gear (gear ratio) Gm of the automatic transmission 4.

A signal from an accelerator opening degree sensor 11 for detecting an accelerator opening degree APO and a signal from a vehicle speed sensor 12 for detecting a vehicle speed VSP are input into the integrated controller 20 to determine the operating point of the power train.

The drive of the motor-generator 1 is controlled by electric power from the battery 21 by way of an inverter 22. During the time when the motor-generator 1 is operated as a generator as described above, the generated electricity therefrom is stored in the battery 21. In this instance, the charging and discharging of the battery 21 is controlled by a battery controller 23 so that the battery 21 is not overcharged. To this end, the battery controller 23 detects a storage condition SOC (electricity that can be taken out) and supplies this information to the integrated controller 20.

Based on the accelerator opening degree APO, the battery storage condition SOC and vehicle speed VSP, the integrated controller 20 selects a driving mode (EV mode, HEV mode) that can realize a vehicle driving force desired by a driver and calculates the engine torque target value tTe, the motor-generator torque target value tTm, the first clutch transmission torque capacity target value tTc1, the second clutch transmission torque capacity target value tTc2 and the target change-speed Gm of the automatic transmission 4. The engine torque target value tTe is supplied to an engine controller 24, and the motor-generator torque target value tTm is transmitted to a motor-generator controller 25.

The engine controller 24 controls the engine 2 so that the engine torque Te becomes equal to the engine torque target value tTe, and the motor-generator controller 25 controls the motor-generator 1 by the power from the battery 21 and by way of the inverter 22 so that the torque Tm of the motor-generator 1 becomes equal to the motor-generator torque target value tTm.

The integrated controller 20 supplies the first transmission torque capacity target value tTc1 and the second clutch transmission torque capacity target value tTc2 to a clutch controller 26. The clutch controller 26 supplies a first solenoid current corresponding to the first clutch transmission torque capacity target value tTc1 to an electromagnetic force control solenoid (not shown) of the first clutch 6 and controls the engagement of the first clutch 6 so that the transmission torque capacity Tc1 of the clutch 6 becomes equal to the transmission torque capacity target value tTc1. The clutch controller 26 also supplies a second solenoid current corresponding to the second clutch transmission torque capacity target value tTc2 to an oil pressure control solenoid of the second clutch 7 and controls the engagement of the second clutch 7 so that the transmission torque capacity Tc2 of the second clutch 7 becomes equal to the second clutch transmission torque capacity target value tTc2.

The target change-speed gear Gm determined by the integrated controller 20 is input to a transmission controller 27, and the transmission controller 27 controls the automatic transmission 4 so that the target change-speed gear (target gear ratio) Gm is selected.

Each controller described herein, including the integrated controller 20, generally consists of a microcomputer including central processing unit (CPU), input and output ports (I/O) receiving certain data described herein, random access memory (RAM), keep alive memory (KAM), a common data bus and read only memory (ROM) as an electronic storage medium for executable programs and certain stored values as discussed hereinafter. The functions of the integrated controller 20 described herein could be, for example, implemented in software as the executable programs, or could be implemented in whole or in part by separate hardware in the form of one or more integrated circuits (IC). Also, although the integrated controller 20 is shown as a separate device from the engine controller 24, the motor-generator controller 25, etc., the controllers can be implemented by fewer devices, including a common device.

A clutch input side rpm sensor 13 detects the rpm of the motor-generator 1 as input side rpm Ni of the second clutch 7, and a clutch output side rpm sensor 14 detects the rpm of the transmission input shaft 4a as output side rpm No of the second clutch 7. The signals from the rpm sensors 13, 14 are input through the clutch controller 26 to the integrated controller 20.

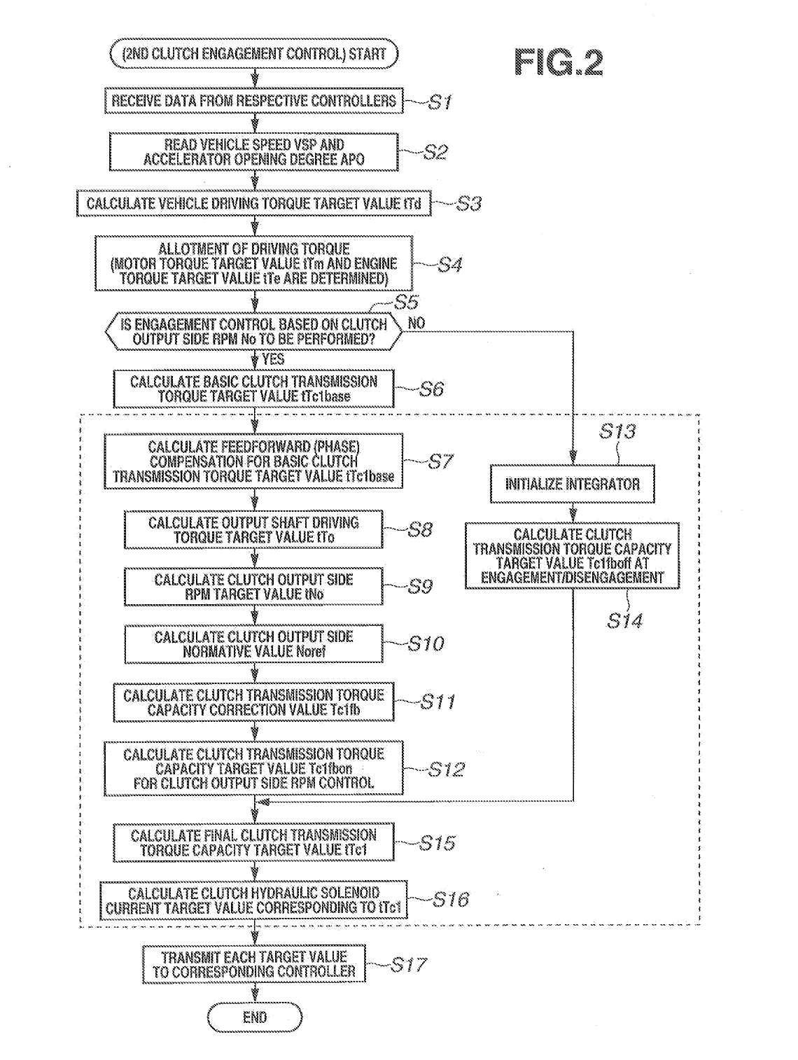

Integrated controller 20 executes the control program of FIG. 2 to control engagement of the second clutch 7. The control program is executed repeatedly according to a time interrupt.

First, in step S1 the data from the respective controllers 23 to 27 are received. The battery storage condition SOC, the input side rpm Ni and the output side rpm No of the second clutch 7 and the selected change-speed gear (selected gear ratio) Gm of the automatic transmission are read. The description made herein assumes that the selected change-speed gear is the same as the above-described target change-speed gear.

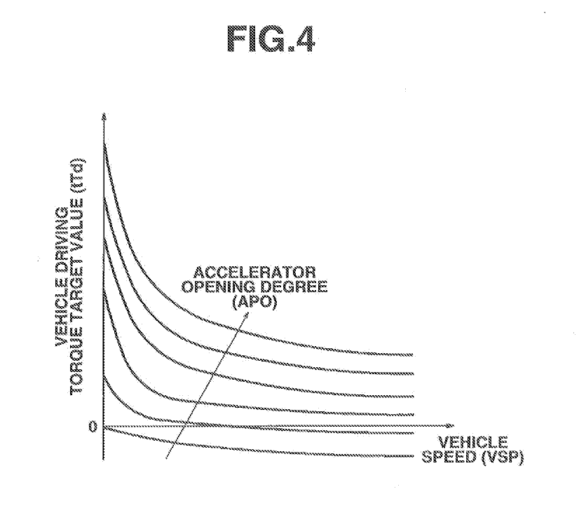

Then, in step S2 the accelerator opening degree APO and the vehicle speed VSP are read based on signals from the sensors 11, 12. Based on a stored driving force map such as that shown by example in FIG. 4, the vehicle driving torque target value tTd is obtained from the vehicle speed VSP and the accelerator opening degree APO in step S3. Thereafter, the motor torque target value tTm and the engine torque target value tTe, which determine how the vehicle driving torque target value tTd is allotted between the motor-generator 1 and the engine 2, are obtained in step S4. These target values are output in step S17, which will be described later, to the motor-generator controller 25 and the engine controller 24, respectively.

In step S5, it is checked whether engagement control is based on the output side rpm No of the second clutch 7. For example, this check is performed by determining whether the slip amount of the second clutch 7 is equal to or larger than a set value. The slip amount of the second clutch 7 is the rotational difference between the input side rpm Ni and the output side rpm No of the second clutch 7. When the slip amount of the second clutch 7 is equal to or larger than a set value, the integrated controller 20 concludes that engagement control of the second clutch 7 based on the output side rpm No should be performed. When the slip amount of the second clutch 7 is or becomes smaller than the set value, engagement control of the second clutch 7 based on the output side rpm No should not be performed.

If it is concluded in step S5 that engagement control based on the output side rpm No of the second clutch 7 should be performed, control proceeds to step S6. Step S6 calculates a basic transmission torque capacity target value tTc1base of the second clutch 7 in accordance with a vehicle driving operation by a driver and a vehicle running condition.

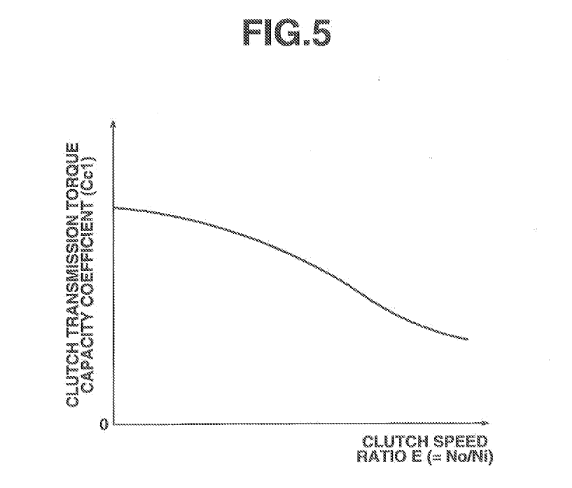

While the basic clutch transmission torque capacity target value tTc1 base can be equal to, for example, the vehicle driving torque target value tTd obtained in step S3 from the accelerator opening degree APO and the vehicle speed VSP, it can alternately obtained as follows. First, using the speed ratio E (=No/Ni), which represents the ratio of the output side rpm No to the input side rpm Ni of the second clutch 7, a transmission torque capacity coefficient Cc1 of the second clutch 7 can be obtained from a torque converter characteristic curve shown by way of example in FIG. 5. Then, the following equation calculates the basic clutch transmission torque capacity target value tTc1base using the coefficient Cc1 and the input side rpm Ni of the second clutch 7:

tTc1base=Cc1×Ni². (1)

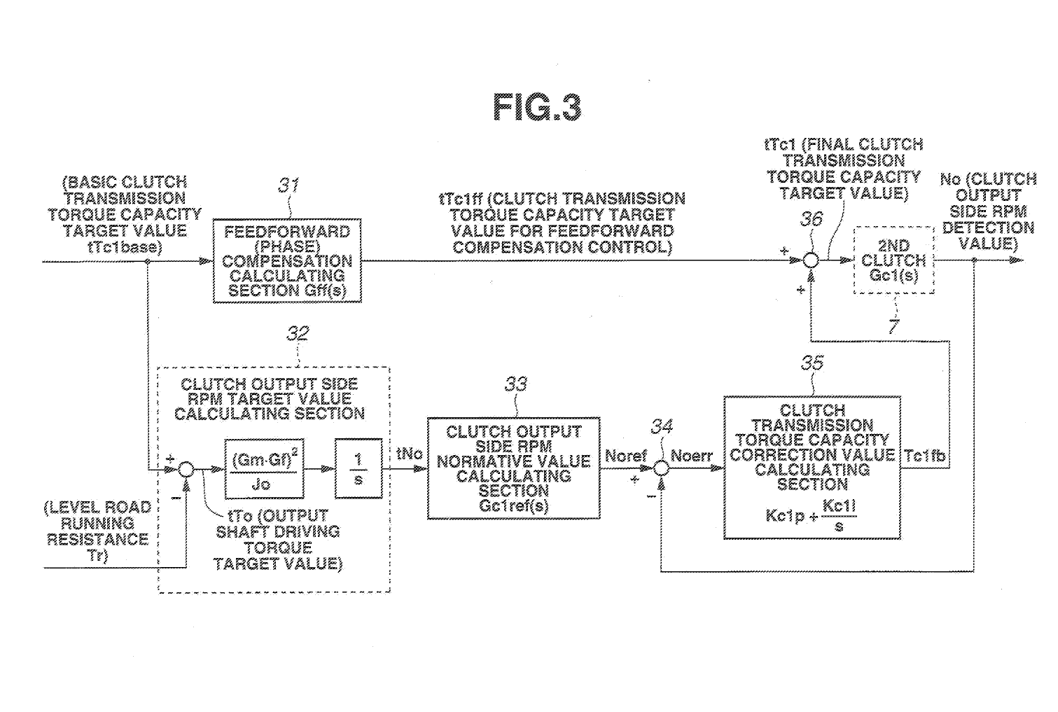

Steps S7 to S16 (enclosed with a dotted line in FIG. 2) are equivalent to the operations described in FIG. 3. Step S7 is equivalent to a feedforward (phase) compensation calculating section 31 shown in FIG. 3. A feedforward (phase) compensator Gff(s) is herein used to apply phase compensation to the basic clutch transmission torque capacity target value tTc1base to calculate the clutch transmission torque capacity target value tTc1ff for feedforward control.

In calculation of the clutch transmission torque capacity target value tTc1ff for feedforward control, the calculation is performed by using the following recurrence formula obtained through discretization by Tustin approximation or the like:

$$\begin{matrix}( Tclff / tTclbase ) = GFF ( s ) \\ = \{ Gclref ( s ) / Gcl ( s ) \} \\ = ( τ cl \cdot s + 1 ) / ( τ clref \cdot s + 1 ) ;\end{matrix} \\ wherein \qquad ( 2 )$$

τc1 is the clutch model time constant; and
τc1 ref is the clutch control normative response time constant.

Step S8 corresponds to the clutch output side rpm target value calculating section 32 shown in FIG. 3. The output shaft driving torque target value tTo is obtained by calculation of the following equation based on the basic clutch transmission torque capacity target value tTc1base and a vehicle running resistance Tr at a level road, which is previously obtained:

tTo=tTc1base−Tr. (3)

Then, the clutch output side rpm target value tNo of the second clutch 7 is calculated by the following equation:

tNo/tTo={(Gm·Gf)²/Jo}×(1/s); wherein (4)
Jo is a moment of inertia of the vehicle; and
Gf is a final reduction ratio of the final reduction gear unit 8 in the vehicle drive train.

The output shaft driving torque target value tTo can be obtained by using, in place of the equation (3), the following equation:

tTo=tTc1base−Tr−(Tslope×Kslope); wherein (5)
Tslope is a slope portion vehicle running resistance due to a road surface slope that is estimated or detected; and
Kslope is a slope portion running resistance coefficient arbitrarily set at a value between 0 and 1.0.

The road surface slope can be estimated from the difference between a vehicle acceleration detection value obtained from an acceleration sensor and a vehicle acceleration calculation value, which is a time-differentiated value of the vehicle speed VSP.

In this instance, depending upon how the slope portion running resistance coefficient Kslope is set, the degree of consideration of the slope portion vehicle running resistance Tslope relative to the output shaft driving torque target value tTo can be freely determined. Namely, when the slope portion running resistance coefficient Kslope is set at 0, the slope portion running resistance Tslope is not reflected on the output shaft driving torque target value tTo. The acceleration ability can be made equal to that at level surface running by making the clutch output side rpm target value tNo obtained by equation (4) equal to that at level surface running. Further, when the slope portion running resistance coefficient Kslope is set at 1, the slope portion running resistance Tslope is reflected 100% on the output torque target value tTo. The acceleration ability can be made equal to that at slope climbing by making the clutch output side rpm target value tNo equal to that at slope climbing. Accordingly, by arbitrarily setting the slope portion running resistance Kslope at a value between 0 and 1, a desired acceleration ability can be realized.

In the next step S9 in FIG. 2 clutch output side rpm target value tNo of the second clutch 7 is restricted so as not to exceed an upper limit tnomax obtained by the following equation:

tNomax=Ni−Nslipmin. (6)

### That is, a clutch output side rpm upper limit value tnomax is obtained by subtracting a minimum clutch slip amount Nslipmin from the input side rpm Ni.

Step S10 is equivalent to a clutch output side rpm normative value calculating section 33 in FIG. 3, and therein a clutch output side rpm normative value Noref for making the output side target value tNo pass a normative model Gc1ref(s) of the second clutch 7 and coincide therewith is calculated.

Calculation of the clutch output side rpm normative value Noref is performed by using the following recurrence formula obtained through discretization by Tustin approximation or the like:

(Noref/tNo)=Gc1ref(s)=1/(τc1ref·s+1). (7)

Clutch output side rpm difference Noerr between the clutch output side rpm normative value Noref and the clutch output side rpm detection value No (that is, Noref−No) is calculated in a clutch output side rpm difference calculating section 34 as shown in FIG. 3.

Step S11 in FIG. 2, which corresponds to a clutch transmission torque capacity correction value calculating section 35 in FIG. 3, calculates a clutch transmission torque capacity correction value Tc1fb. The clutch transmission torque capacity correction value Tc1fb is a clutch transmission torque capacity feedback control amount for making the clutch output side rpm difference Noerr zero, i.e., for coinciding the clutch output side rpm detection value No with the clutch output side rpm normative value Noref.

Calculation of the clutch transmission torque capacity correction value Tc1fb is performed using the following recurrence formula obtained through discretization by Tustin approximation or the like:

Tc1fb={Kc1p+(Kc1i/s)}·Noerr; wherein (8)
Kc1p is a proportional control gain; and
Kc1i is an integration control gain.

Steps S12 and S15 in FIG. 2 correspond to a clutch transmission torque capacity target value calculating section 36 for a clutch output side rpm control as shown in FIG. 3.

In step S12 the clutch transmission torque capacity target value tTc1ff for feedforward control and the clutch transmission torque capacity correction value Tc1fb are added together to obtain a clutch transmission torque capacity target value Tc1fbon for clutch output side rpm control. In step S15 the clutch transmission torque capacity target value Tc1fbon for clutch output side rpm control is used as the final clutch transmission torque capacity target value tTc1.

Referring to FIG. 2, when it is instead concluded in step S5 that engagement control based on the output side rpm No should not be made, the integrated controller 20 proceeds to step S13. At step S13, the integrator used for obtaining the clutch transmission torque capacity correction value Tc1fb in step S11 is initialized to zero, while the clutch output side rpm target value tNo in step S8 is initialized to the clutch output side rpm detection value No.

After step S13, a clutch transmission torque capacity target value Tc1fboff is calculated for clutch normal control. Clutch transmission torque capacity target value Tc1fboff can either put the second clutch 7 into an engaged condition or disengaged condition or keep the conditions in steady state. Clutch transmission torque capacity target value Tc1fboff can be used for clutch normal control from the time of those conditions in steady state to the time the second clutch 7 begins engagement control based on the output side rpm No.

Clutch transmission torque capacity target value Tc1fboff for clutch normal control is set at a maximum value that the second clutch 7 can realize to put the second clutch 7 into an engaged condition or keep the condition in steady state. Clutch transmission torque capacity target value Tc1fboff for clutch normal control is reduced gradually from an existing transmission torque capacity of the second clutch 7 to put the second clutch 7 into a disengaged condition or to keep the disengaged condition in a steady-state.

When a loop passing through steps S7 to S12 is selected in response to a conclusion in step S5 that engagement control based on the output side rpm No should be performed, clutch transmission torque capacity target value Tc1fbon for clutch output side rpm control (obtained in step S12) is selected as the final clutch transmission torque capacity target value tTc1 in step S15 as described above. In contrast, when the loop passing through steps S13 and S14 is selected in response to a conclusion in step S5 that engagement control based on the output side rpm No should not be made, the clutch transmission torque capacity target value Tc1fboff for clutch normal control (obtained in step S14) is selected as the final clutch transmission torque capacity target value tTc1 in step S15.

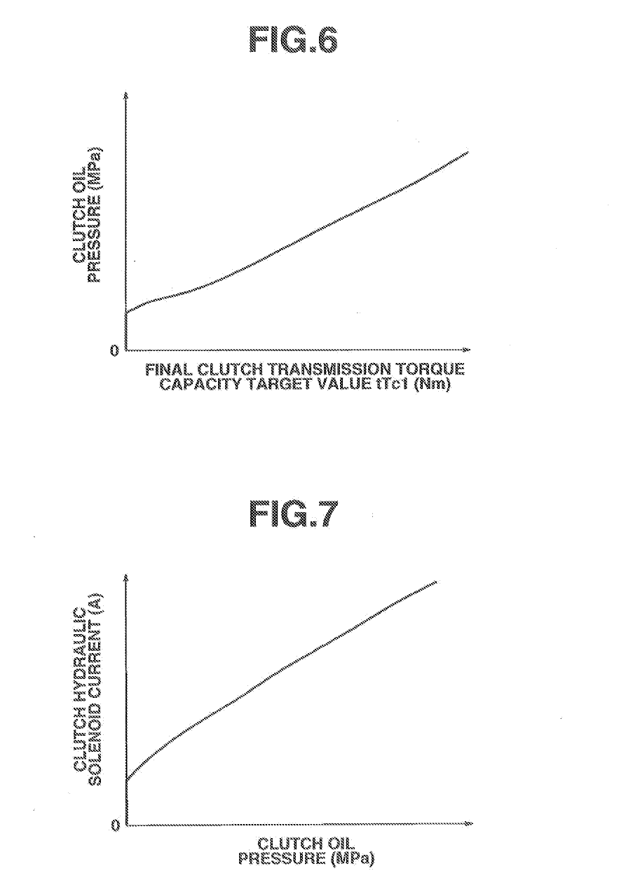

In next step S16 the hydraulic solenoid current of the second clutch 7 needed to attain the final clutch transmission torque capacity target value tTc1 is determined as follows. First, the clutch oil pressure of the second clutch 7 that can realize the final clutch transmission torque capacity target value tTc1 is retrieved based on a stored correlation curve, or map, such as that shown by way of example in FIG. 6. Then, the oil pressure solenoid current of the second clutch 7 that can generate the retrieved clutch oil pressure is determined based on another stored correlation curve, or map, such as that shown by way of example in FIG. 7.

The hydraulic solenoid current of the second clutch 7 so determined is supplied to the clutch controller 26 in step S17. Clutch controller 26 controls engagement of the second clutch 7 so that the transmission torque capacity coincides with the final clutch transmission torque capacity target value tTc1. Additionally, in step S17, as described previously, the motor torque target value tTm obtained in step S4 and the engine torque target value tTe are output to the motor-generator controller 25 and the engine controller 24, respectively.

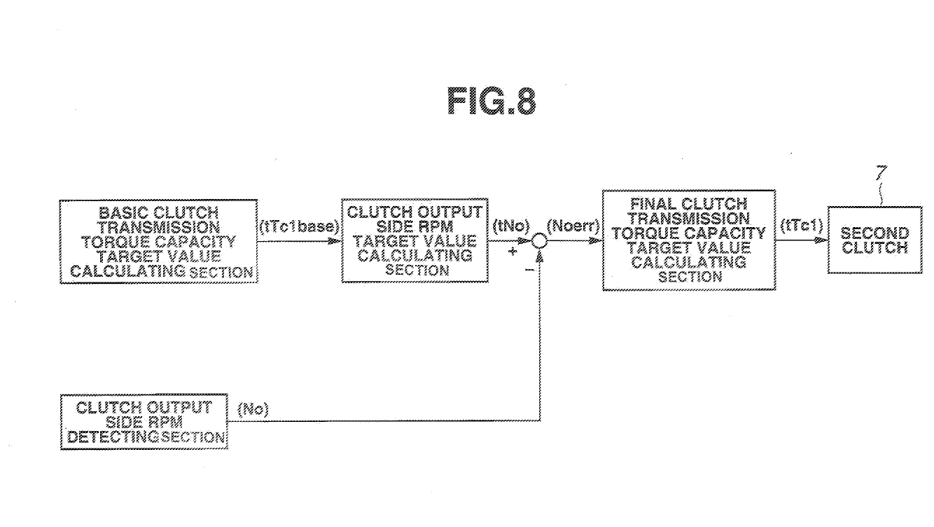

As shown by the functional block diagram of FIG. 8, the basic transmission torque capacity target value tTc1base in accordance with the vehicle driving operation and the vehicle running condition is calculated by the basic clutch transmission torque capacity target value calculating section in this embodiment. In addition, the output side rpm target value tNo is calculated from the basic clutch transmission torque capacity target value tTc1base by the clutch output side rpm target value calculating section. Also the final transmission torque capacity target value tTc1 of the second clutch 7 that makes smaller the clutch output side rpm difference Noerr between the clutch output side rpm target value tNo and the clutch output side rpm detection value No detected by the clutch output side rpm detection section is calculated by the final clutch transmission torque capacity target value calculating section. Finally engagement of the second clutch 7 is controlled so that the transmission torque capacity of the second clutch 7 coincides with the final clutch transmission torque capacity target value tTc1.

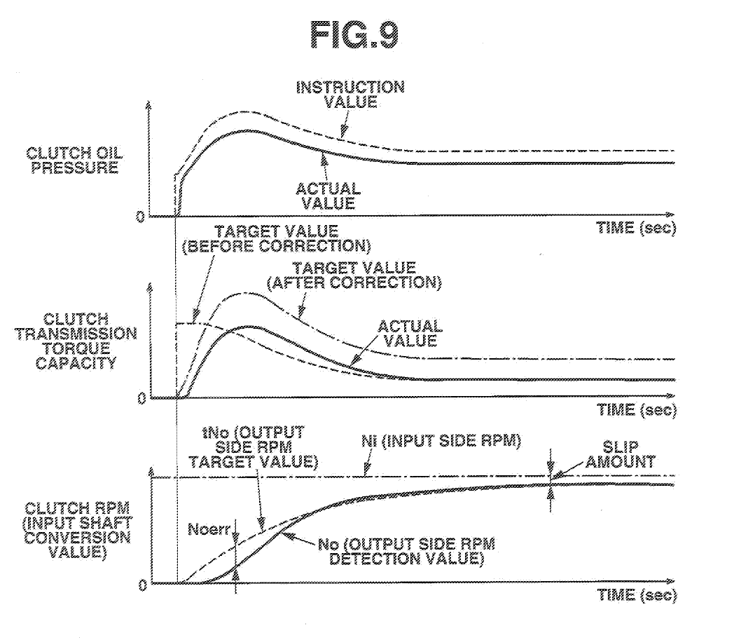

By this control, the following effects are obtained. Hereinafter, description is made in accordance with FIG. 9, which is a time chart of clutch engagement control according to the block diagram of FIG. 8.

Since in engagement control of the second clutch 7, the final clutch transmission torque capacity target value tNo makes smaller the clutch output side rpm difference Noerr between the clutch output side rpm target value tNo obtained from the basic clutch transmission torque capacity target value tTc1 base and the clutch output side rpm detection value No, it becomes possible to make the difference Noerr smaller as shown and cause the clutch output side rpm detection value No to converge into the clutch output side rpm target value tNo when the clutch output side rpm difference Noerr is about to become larger due to disturbance as shown in FIG. 9. So, even at the time of occurrence of a disturbance, the slip (Ni−No) of the second clutch 7 can be made smaller to enable engagement of the second clutch 7. A potential problem of deterioration of the second clutch 7 being accelerated by slippage for a long time can be eliminated.

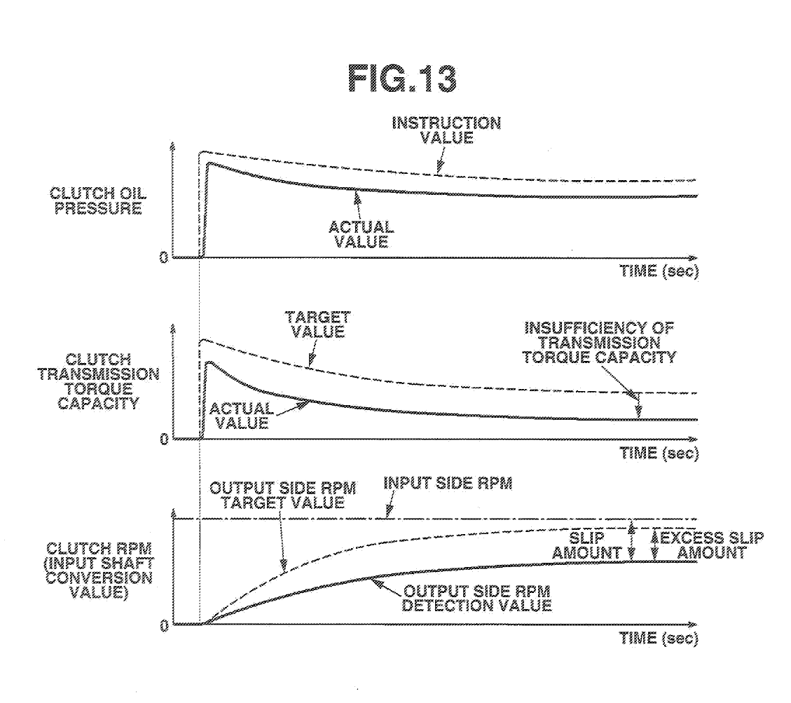

For comparison with this, the operation of a comparative example in which a clutch engagement control of this embodiment is not used is illustrated with reference to FIG. 13. Referring now to FIG. 13, the clutch oil pressure instruction value by the feedforward control is indicated by the dashed line. In contrast to this line, when a disturbance such as an oil temperature variation or an ageing deterioration of the clutch is caused, the clutch oil pressure is actually lowered as indicated by the solid line to cause the actual clutch transmission torque capacity obtained by the clutch oil pressure to become insufficient relative to the target value indicated by the dashed line. In this case, the actual clutch output side rpm, as indicated by the solid line, is considerably lower than the clutch output side rpm target value as indicated by the dashed line. A clutch slip amount represented by the difference between the actual clutch output side rpm and the clutch input side rpm as indicated by the one-dot chain line becomes excessively large (by an amount corresponding to the difference between the clutch output side rpm detection value and the clutch output side rpm target value as indicated by the dashed line). This excess slippage disables engagement of the clutch can result in a problem in that slippage for a long time quickens deterioration of the clutch.

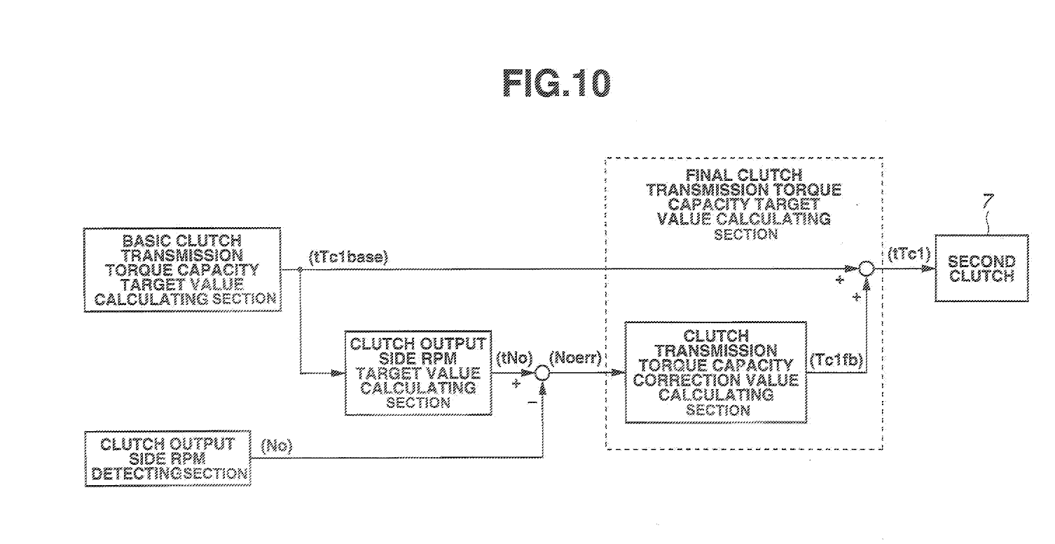

Also, calculation of the final clutch transmission torque capacity target value tTc1 can performed as shown by the functional block diagram of FIG. 10. According to this calculation, the following effects are obtained.

The basic transmission torque capacity target value tTc1base in accordance with the vehicle driving operation and the vehicle running condition is calculated by the basic clutch transmission torque capacity target value calculating part as in FIG. 8. Then, the output side rpm target value tNo is calculated from the basic clutch transmission torque capacity target value tTc1 base by the clutch output side rpm target value calculating section. The clutch transmission torque capacity correction value Tc1fb that makes smaller the clutch output side rpm difference Noerr between the clutch output side rpm target value tNo and the clutch output side rpm detection value No detected by the clutch output side rpm detection means is first calculated in the calculation of the final transmission torque target value tTc1 by the final clutch transmission torque target value calculating section. Then the basic clutch transmission torque capacity target value tTc1base corrected by the clutch transmission torque capacity correction value Tc1fb is used as the final transmission torque capacity target value tTc1 for thereby contributing to the engagement control of the second clutch 7.

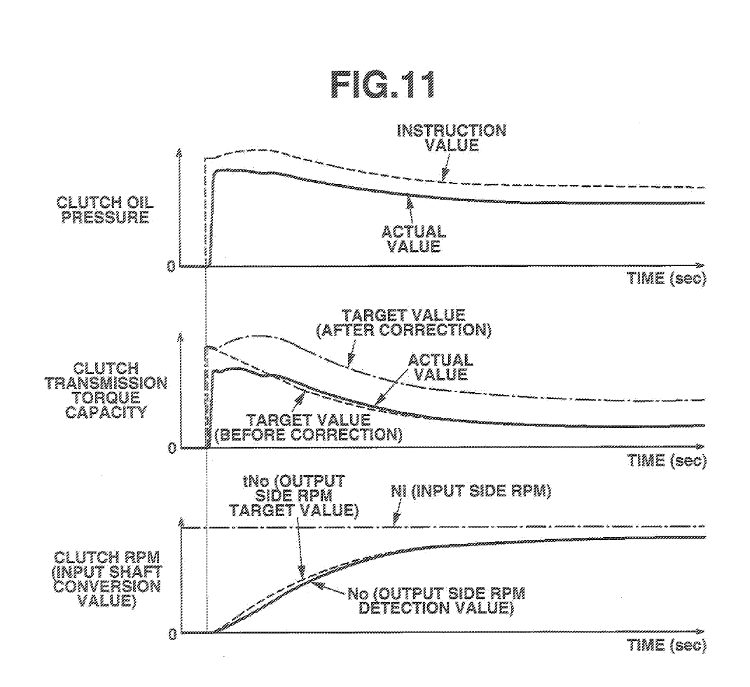

Hereinafter, description is made in accordance with FIG. 11, which is a time chart of clutch engagement control according to the block diagram of FIG. 10.

By such a calculation method of the final clutch transmission torque capacity target value tTc1 as described in FIG. 10, feedback compensation of the clutch output side rpm is applied to the basic clutch transmission torque capacity target value tTc1base. Therefore, as is apparent from the characteristic of the output side rpm detection value No with respect to the clutch output side rpm target value tNo as shown in FIG. 11, control to follow the target can be made more accurate than that in FIG. 9, and the effects described with respect to FIG. 9 can be more pronounced.

Further, in obtaining the clutch output side rpm target value tNo, the output shaft driving torque target value tTo is first obtained by the calculation of equation (3) based on the basic clutch transmission torque capacity target value tTc1bse and the level road running resistance Tr as described above. Then the clutch output side rpm target value tNo is obtained by the calculation of equation (4) based on the output shaft driving torque target value tTo, the moment of inertia of the vehicle Jo, the gear ratio Gm of the automatic transmission 4 and the final reduction ratio Gf of the final reduction gear unit 8. Accordingly, a vehicle acceleration ability similar to that in the case of no occurrence of disturbance can be assured even when a disturbance due to a torque capacity variation of the second clutch 7 and a road slope is caused.

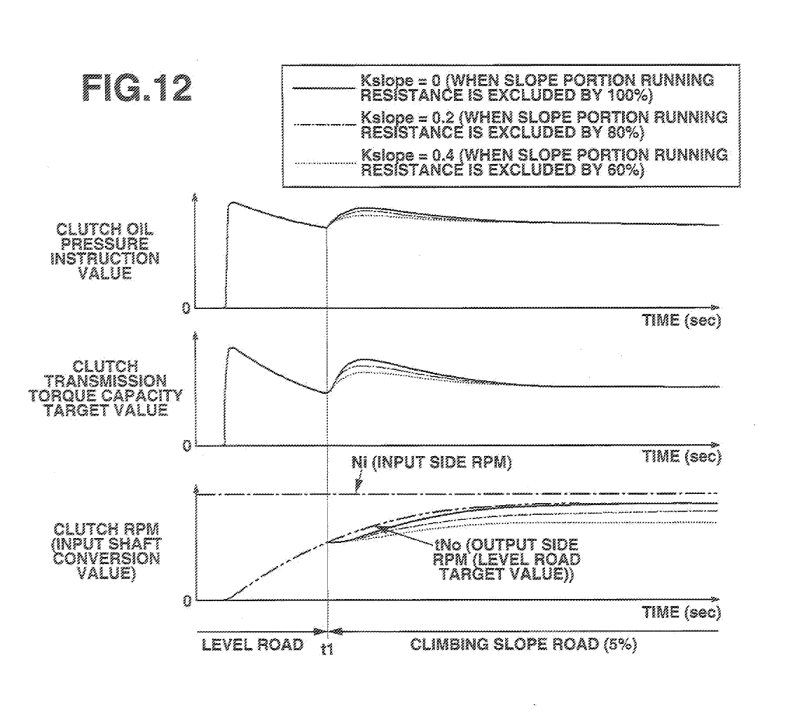

By using equation (5) in place of the equation (3) as described above to thereby obtaining the output shaft torque target value tTo from the basic clutch transmission torque capacity target value tTc1base, the level road resistance value Tr and the slope portion running resistance coefficient Kslope, how much an influence of the road slope on the vehicle acceleration is excluded can be determined freely depending on a value of the slope portion running resistance coefficient Kslope. Here, FIG. 12 is a time chart showing a clutch engagement control executed by a clutch engagement control apparatus of FIG. 2 during transition from level road running to slope climbing. Hereinafter, description will be made with reference to FIG. 12.

In this instance, three cases are shown in the time charts of FIG. 12. Shown is a first case where the slope portion running resistance Kslope is 0 (that is, the slope portion running resistance is excluded by 100%), a second case where the slope portion running resistance Kslope is 0.2 (that is, the slope portion running resistance is excluded by 80%) and a third case where the slope portion running resistance Kslope is 0.4 (that is, the slope portion running resistance is excluded by 60%). After the moment t1 of transition from level road running to slope climbing, the clutch output side rpm target value tNo can be varied even under the same clutch input side rpm Ni. For example, the vehicle speed at creeping can be set arbitrarily for preventing a strange feel due to excessive vehicle speed rise.

Further, the clutch output side rpm target value tNomax is restricted in step S9 of FIG. 2 so that the clutch output side rpm upper limit tNmax that is obtained by subtracting the minimum clutch slip amount Nslipmin from the input side rpm Ni does not exceed the clutch output side rpm target value tNo as described previously. It thus becomes possible to prevent, by restricting a rise of the rpm target value tNo, such a phenomenon that when the input side rpm Ni of the second clutch 7 is lowered by a torque variation of the engine 2 or by restriction of the upper limit torque of the motor-generator 1, the clutch output side rpm No is also lowered to cause rapid engagement of the second clutch 7 and thereby cause a variation of acceleration.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A clutch engagement control apparatus for a hybrid vehicle, comprising:
a plurality of different kinds of power sources;
a clutch interposed between the power sources and driving wheels, the clutch capable of varying a transmission torque capacity and having an input side and an output side;
a clutch output side rpm detecting device that detects an rpm detection value of the output side of clutch; and
a controller configured to:
calculate a basic transmission torque capacity target value of the clutch based on a vehicle driving operation by a driver and a vehicle running condition;
calculate a target rpm value for the output side of the clutch based on the basic clutch transmission torque capacity target value;
calculate a final transmission torque capacity target value for the clutch that decreases a difference between the target rpm value and the rpm detection value; and
control engagement of the clutch so that the transmission torque capacity of the clutch becomes equal to the final transmission torque capacity target value.

2. The apparatus according to claim 1 wherein the controller is further configured to:
calculate a transmission torque capacity correction value that decreases the difference between the target rpm value and the rpm detection value; and
calculate the final transmission torque capacity target value by correcting the basic clutch transmission torque capacity target value with the transmission torque capacity correction value.

3. The apparatus according to claim 2 wherein the controller is further configured to calculate the transmission torque capacity correction value Tc1fb according to an equation Tc1fb=Kc1p+(Kc1i/s)}·Noerr wherein Kc1p is a proportional control gain, Kc1i is an integration control gain, and Noerr is the difference between the target rpm value and the rpm detection value.

4. The apparatus according to claim 1 wherein the controller is further configured to:
calculate an output shaft driving torque target value tTo according to an equation tTo=tTc1base−Tr wherein tTc1base is the basic clutch transmission torque capacity target value and Tr is a vehicle running resistance at a level road; and
calculate the target rpm value tNo according to an equation tNo/tTo={(Gm·Gf)²/Jo}×1/s) wherein Jo is a moment of inertia of the vehicle, Gm is a gear ratio of a transmission in a drive train of the vehicle and Gf is a final reduction ratio of a final reduction gear unit in the drive train.

5. The apparatus according to claim 1 wherein the controller is further configured to:
calculate an output shaft driving torque target value tTo according to an equation tTo=tTc1base−Tr−(Tslope×Kslope) wherein tTc1base is the basic clutch transmission torque capacity target value, Tr is a vehicle running resistance at a level road, Tslope is a slope portion vehicle running resistance due to a road surface slope, and Kslope is a slope portion running resistance coefficient between 0 and 1.0; and
calculate the target rpm value tNo according to an equation tNo/tTo={(Gm·Gf)²/Jo}×1/s) wherein Jo is a moment of inertia of the vehicle, Gm is a gear ratio of a transmission in a drive train of the vehicle and Gf is a final reduction ratio of a final reduction gear unit in the drive train.

6. The apparatus according to claim 1, further comprising:
a clutch input side rpm detecting device that detects a clutch input side rpm detection value of the input side of the clutch; and wherein the controller is further configured to:
calculate a clutch output side rpm upper limit value by subtracting a predetermined value from the clutch input side rpm detection value; and
restrict the target rpm value by the clutch output side rpm upper limit value.

7. The apparatus according to claim 1 wherein the plurality of different kinds of power sources comprise:
an engine; and
a motor disposed between the engine and the input side of the clutch, the apparatus further comprising:
a second clutch disposed between the engine and the motor.

8. A clutch engagement control apparatus for a hybrid vehicle including a power train having at least two power sources and a clutch between the at least two power sources and a driving wheel, the apparatus comprising:
means for calculating a basic transmission torque capacity target value of the clutch based on a vehicle driving operation by a driver and a vehicle running condition;
means for calculating a target rpm value for the output side of the clutch based on the basic clutch transmission torque capacity target value;
means for calculating a final transmission torque capacity target value for the clutch that decreases a difference between the target rpm value and a detected rpm value on the output side of the clutch; and
means for controlling engagement of the clutch so that the transmission torque capacity of the clutch becomes equal to the final transmission torque capacity target value.

9. The apparatus according to claim 8, further comprising:
means for detecting the detected rpm value on the output side of the clutch.

10. A clutch engagement control method for a hybrid vehicle including a power train having at least two power sources and a clutch between the at least two power sources and a driving wheel, the method comprising:
calculating a basic transmission torque capacity target value of the clutch based on a vehicle driving operation by a driver and a vehicle running condition;
calculating a target rpm value for an output side of the clutch based on the basic clutch transmission torque capacity target value;
calculating a final transmission torque capacity target value for the clutch that decreases a difference between the target rpm value and a detected rpm value on the output side of the clutch; and
controlling engagement of the clutch so that the transmission torque capacity of the clutch becomes equal to the final transmission torque capacity target value.

11. The method according to claim 10, further comprising:
calculating a transmission torque capacity correction value that decreases the difference between the target rpm value and the detected rpm value; and wherein calculate the final transmission torque capacity target value further comprises:
correcting the basic clutch transmission torque capacity target value with the transmission torque capacity correction value to obtain the final transmission torque capacity target value.

12. The method according to claim 11 calculating the transmission torque capacity correction value further comprises:
calculating the transmission torque capacity correction value Tc1fb according to an equation Tc1fb={Kc1p+(Kc1i/s)}·Noerr wherein Kc1p is a proportional control gain, Kc1i is an integration control gain, and Noerr is the difference between the target rpm value and the detected rpm value.

13. The method according to claim 11, further comprising:
detecting a clutch input side rpm detection value of an input side of the clutch;
calculating a clutch output side rpm upper limit value by subtracting a predetermined value from the clutch input side rpm detection value; and
restricting the target rpm value by the clutch output side rpm upper limit value.

14. The method according to claim 10, further comprising:
calculating an output shaft driving torque target value tTo according to an equation tTo=tTc1base−Tr wherein tTc1base is the basic clutch transmission torque capacity target value and Tr is a vehicle running resistance at a level road; and wherein calculating the target rpm value further comprises:
calculating the target rpm value tNo according to an equation tNo/tTo=((Gm·Gf)2/Jo}×1/s) wherein Jo is a moment of inertia of the vehicle, Gm is a gear ratio of a transmission in a drive train of the vehicle and Gf is a final reduction ratio of a final reduction gear unit in the drive train.

15. The method according to claim 10, further comprising:
calculating an output shaft driving torque target value tTo according to an equation tTo=tTc1base−Tr−(Tslope×Kslope) wherein tTc1base is the basic clutch transmission torque capacity target value, Tr is a vehicle running resistance at a level road, Tslope is a slope portion vehicle running resistance due to a road surface slope, and Kslope is a slope portion running resistance coefficient between 0 and 1.0; and wherein calculating the target rpm value further comprises:
calculating the target rpm value tNo according to an equation tNo/tTo={(Gm·Gf)2/Jo}×1/s) wherein Jo is a moment of inertia of the vehicle, Gm is a gear ratio of a transmission in a drive train of the vehicle and Gf is a final reduction ratio of a final reduction gear unit in the drive train.

16. The method according to claim 10, further comprising:
detecting the detected rpm value on the output side of the clutch.

17. The method according to claim 10, further comprising:
detecting a clutch input side rpm detection value of an input side of the clutch;
calculating a clutch output side rpm upper limit value by subtracting a predetermined value from the clutch input side rpm detection value; and
restricting the target rpm value by the clutch output side rpm upper limit value.

18. The method according to claim 10 wherein calculating the basic transmission torque capacity target value of the clutch based on the vehicle driving operation by the driver and the vehicle running condition further comprises:
determining a vehicle driving torque target value using an accelerator opening degree and a vehicle speed, the vehicle driving torque target value being the basic transmission torque capacity target value.

19. The method according to claim 10, further comprising:
obtaining a transmission torque capacity coefficient Cc1 of the clutch using a speed ratio of the detected rpm value to a clutch input side rpm detection value Ni of an input side of the clutch and a predetermined relationship between transmission torque capacity coefficients and speed ratios; and wherein calculating the basic transmission torque capacity target value of the further comprises:
calculating the basic transmission torque capacity target value tTc1base according to an equation tTc1base=Cc1×Ni².
